(19) United States
(12) Patent Application Publication
(10) Pub. No.: US 2024/0262429 A1
(43) Pub. Date: Aug. 8, 2024

(54) VEHICLE LOWER PORTION STRUCTURE

(71) Applicant: TOYOTA JIDOSHA KABUSHIKI KAISHA, Aichi-ken (JP)

(72) Inventors: Soshiro MURATA, Toyota-shi (JP); Shigenori HASHIDA, Nisshin-shi (JP)

(21) Appl. No.: 18/434,659

(22) Filed: Feb. 6, 2024

(30) Foreign Application Priority Data
Feb. 6, 2023 (JP) 2023-015867

(51) Int. Cl. B62D 25/02; B62D 25/20

(52) U.S. Cl. CPC B62D 25/025; B62D 25/2036

(57) ABSTRACT

A vehicle lower portion structure includes a pair of side sills extending along the longitudinal direction, and further includes a front frame member extending upward the side sill along a front edge of a door opening defined in a side surface of the vehicle, and further includes a rear frame member extending upwardly from the side sill along a rear edge of the door opening, and further includes a front floor cross member and a rear floor cross member. The front floor cross member is disposed forward of the front edge of the door opening and connected to the side sill and the front frame member. The rear floor cross member is disposed rearward of the rear edge of the door opening and connected to the side sill and the rear frame member.

### CROSS REFERENCE TO RELATED APPLICATION

This application claims priority to Japanese Patent Application No. 2023-015867 filed on Feb. 6, 2023, which is incorporated herein by reference in its entirety including the specification, claims, drawings, and abstract.

### TECHNICAL FIELD

The present disclosure relates to a vehicle lower portion structure in which a floor cross member extending in the vehicle width direction connects to a side sill.

### BACKGROUND

JP 2021-006437 A discloses a vehicle lower portion structure with a pair of side members arranged on both sides in the vehicle width direction and extending along the longitudinal direction, and a cross member extending along the vehicle width direction and connecting the pair of side members, and a battery is stored in the space under the floor between the pair of side members.

As shown in FIG. 5, a vehicle lower portion structure 4 is known in which a battery 3 is stored in the space under the floor between a pair of side sills 1, which are arranged on both sides of the vehicle in the vehicle width direction and extend in the front-back direction, and a plurality of floor cross members 2 that extend in the vehicle width direction and connect a pair of side sills 1. In such a vehicle in which the battery 3 is stored in the space under the floor between a pair of side sills 1, the floor cross member 2 must be installed above the battery 3 to avoid interference with the battery 3. However, installing the floor cross member 2 above the battery 3 raises the position of the top edge of the side sill 1 to which the floor cross member 2 is connected, and also raises the position of the floor panel to be placed on top of the floor cross member 2, thus making it difficult to get in and out of the vehicle. If the floor cross member 2 is deleted to prevent such deterioration in ease of entry and exit, the side sill 1 on the side that is struck by the collision may bend and damage the battery 3 because the floor cross member 2 cannot transmit the load from the side sill 1 on the side that is struck to the side sill 1 on the opposite side in the event of a side collision. This may cause the side sill 1 on the side of the collision to bend and damage the battery 3.

### SUMMARY

Given the above circumstances, an advantageous effect of the present disclosure is to provide a vehicle lower portion structure in which the vehicle substructure secures the floor cross member that transfers the load from the side sill on the side struck by the side impact to the side sill on the opposite side while improving vehicle accessibility.

According to an aspect of the present disclosure, a vehicle lower portion structure includes a pair of side sills extending along the longitudinal direction of a vehicle between a front wheel house and a rear wheel house, in which the side sills are respectively disposed on both ends, in the vehicle width direction, of the vehicle. The vehicle lower portion structure further includes a front frame member connected to the side sill and extending upward the side sill along a front edge of a door opening defined in a side surface of the vehicle, and further includes a rear frame member connected to the side sill and extending upwardly from the side sill along a rear edge of the door opening. The vehicle lower portion structure further includes a front floor cross member extending along the vehicle width direction, and further includes a rear floor cross member extending along the vehicle width direction. The front floor cross member is disposed forward of the front edge of the door opening and connected to the side sill and the front frame member. The rear floor cross member is disposed rearward of the rear edge of the door opening and connected to the side sill and the rear frame member.

According to an aspect of this disclosure, in the vehicle lower portion structure, a battery may be disposed between the pair of side sills.

According to an aspect of this disclosure, in the vehicle lower portion structure, a floor panel may further be included. The floor panel has a portion defining a lower edge of the door opening, the portion being connected to an upper end of the side sill.

The present disclosure can provide the vehicle lower portion structure in which the vehicle substructure secures the floor cross member that transfers the load from the side sill on the side struck by the side impact to the side sill on the opposite side while improving vehicle accessibility.

### BRIEF DESCRIPTION OF DRAWINGS

Embodiments of the present disclosure will be described based on the following figures, wherein:

FIG. 1 is a side view of a vehicle equipped with a vehicle lower portion structure according to a at least one embodiment, viewed from the left side;

FIG. 2 is a cross-sectional view of line A-A in FIG. 1:

FIG. 3 is a cross-sectional view of line B-B in FIG. 1:

FIG. 4 is a side view of a vehicle equipped with a vehicle lower portion structure according to a at least one embodiment, viewed from the left side; and

FIG. 5 is a left side view of a vehicle equipped with a vehicle lower portion structure, viewed from the left side.

### DESCRIPTION OF EMBODIMENTS

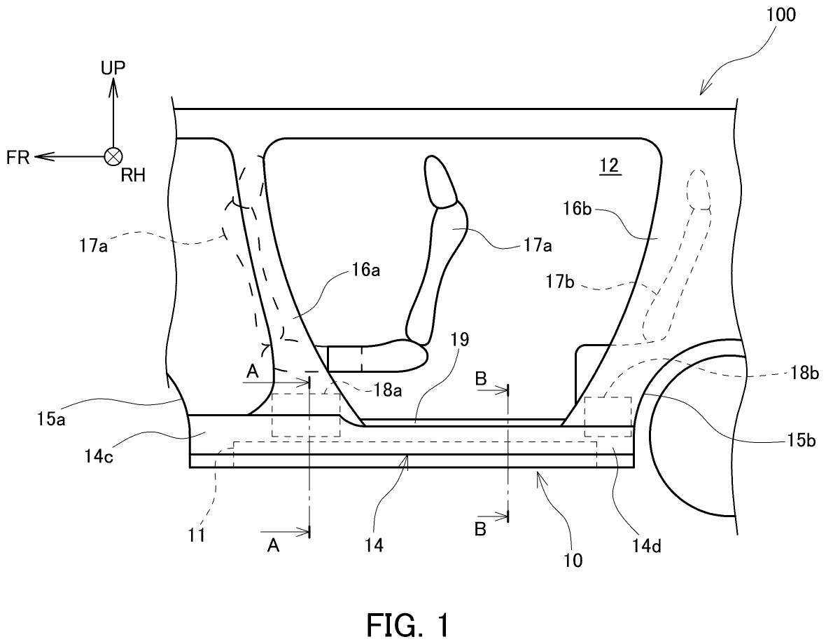

Hereinafter, embodiments of a vehicle lower portion structure according to this disclosure will be described with reference to the FIG. 1-3. Arrows FR, UP, and RH shown in the drawings which will be referenced in the following explanation represent a forward direction (a travel direction), an upward direction, and a right hand direction of a vehicle, respectively. Further, directions opposite to those indicated by the arrows FR, UP, and RH represent a rearward direction, a downward direction, and a left hand direction of the vehicle, respectively. Hereinafter, unless otherwise specified, descriptions simply using terms of forward, rearward, right, left, upward, downward, and the like will denote forward or rearward in a vehicle longitudinal direction, right or left in a vehicle lateral direction (vehicle width direction), and upward or downward in a vehicle vertical direction.

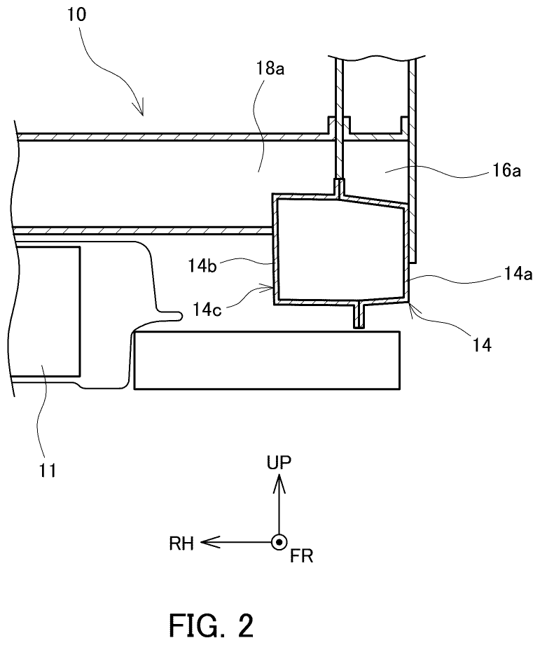

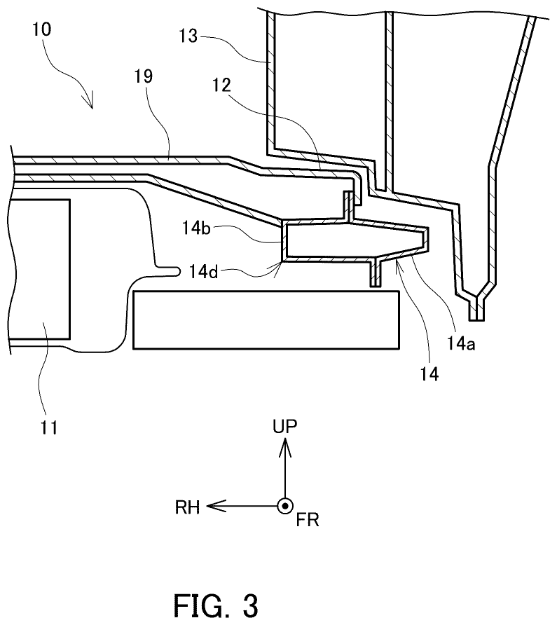

FIG. 1 is a side view of a vehicle 100 equipped with the vehicle lower portion structure of at least one embodiment, viewed from the left side. FIG. 2 is a cross-sectional view of line A-A in FIG. 1. FIG. 3 is a cross-sectional view of line B-B in FIG. 1. The vehicle 100 is an electric vehicle with a battery 11 mounted under the floor. As shown in FIG. 1 and FIG. 3, a door opening 12 is formed on the side of the vehicle 100. The side door 13, which closes the door opening 12, is omitted in FIG. 1, but is shown in FIG. 3. FIG. 3 shows the side door 13 in a closed position.

As shown in FIG. 1-3, the vehicle lower portion structure 10 has side sills 14 that form part of the framework of the vehicle body. The side sills 14 are located at the ends of both sides of the vehicle in the vehicle width direction and extend along the longitudinal direction of a vehicle between a front wheel house 15a and a rear wheel house 15b. As shown in FIG. 2-3, the side sill 14 is formed into a closed cross-section by the side sill outer panel 14a and the side sill inner panel 14b being joined at the upper and lower ends. As shown in FIG. 1-3, the side sill 14 has different top edge heights at the front 14c and rear 14d. The rear 14d along the lower edge of the door opening 12 has a lower top edge height than the front 14c.

The vehicle lower portion structure 10 has a front side skeletal member 16a that connects to the side sill 14. The front side skeletal skeleton member 16a is the B-pillar of the vehicle 100. The front side skeletal skeleton member 16a extends upward from the side sill 14 along the front edge of the door opening 12. The vehicle lower portion structure 10 has a rear side skeletal skeleton member 16b that connects to the side sill 14. The rear side skeletal skeleton member 16b extends upwardly from the side sill 14 along the rear edge of the door opening 12.

The front seats 17a and rear seats 17b are located in the vehicle compartment. The door opening 12 is used for boarding the vehicle into the space between the front seat 17a and the rear seat 17b, and for exiting the vehicle from the space between the front seat 17a and the rear seat 17b. The front seat 17a is pivotably attached to the vehicle body and can be forward-facing, as shown in solid line in FIG. 1, or rear-facing, as shown in broken line in FIG. 1. When the front seat 17a is rear-facing, the occupants of the vehicle 100 can sit facing each other in the front seat 17a and the rear seat 17b.

The vehicle lower portion structure 10 has a front side floor cross member 18a and a rear side floor cross member 18b. Both the front side floor cross member 18a and the rear side floor cross member 18b extend along the vehicle width direction and connect the side sills 14 on the left and right sides. The front side floor cross member 18a is disposed forward of the front edge of the door opening 12. The front side floor cross member 18a is connected at the edge in the vehicle width direction so as to span the upper portion of the side sill 14 and the lower portion of the front side skeleton member 16a. The rear side floor cross member 18b is disposed behind the rear edge of the door opening 12. The rear side floor cross member 18b is connected at the edge in the vehicle width direction so as to span the upper portion of the side sill 14 and the lower portion of the rear side skeletal skeleton member 16b.

The vehicle lower portion structure 10 has a floor panel 19. The floor panel 19 is a plate-like member that forms the floor of the vehicle compartment. The floor panel 19 forms the lower edge of the door opening 12. Both ends of the floor panel 19 in the vehicle width direction are connected to the upper edge of the side sill 14 at the portion forming the lower edge of the door opening 12. The vehicle lower portion structure 10 has a battery 11 located between the side sills 14 on both the left and right sides. The battery 11 is stored in the space below the floor panel 19, the front side floor cross member 18a and the rear side floor cross member 18b. Battery 11 is used to supply power to an unshown running motor.

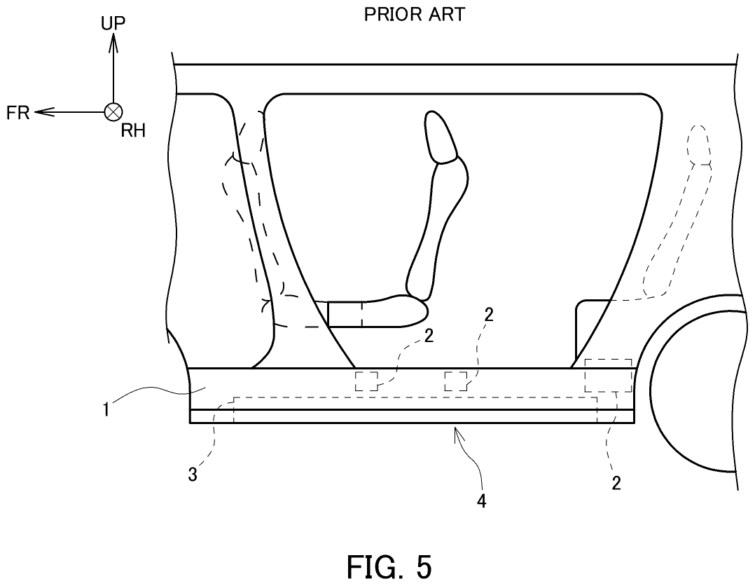

In the vehicle lower portion structure 10, the front side floor cross member 18a is disposed forward of the front edge of the door opening 12 and the rear side floor cross member 18b is disposed rearward of the rear edge of the door opening 12 as described above. Therefore, unlike the prior art vehicle lower portion structure 4 shown in FIG. 5, the vehicle lower portion structure 10 has no floor cross member below the lower edge of the door opening 12. Therefore, the vehicle lower portion structure 10 can lower the height of the upper edge of the side sill 14 along the lower edge of the door opening 12 compared to the vehicle lower portion structure 4 shown in FIG. 5. In addition, because the vehicle lower portion structure 10 connects the floor panel 19 to the upper edge of the side sill 14 at the portion where the floor panel 19 forms the lower edge of the door opening 12, the floor panel 19 can be installed at a lower position compared to the vehicle lower portion structure 4 shown in FIG. 5. Therefore, the vehicle lower portion structure 10 can improve the ease of entering and exiting the vehicle compared to the prior art vehicle lower portion structure 4 shown in FIG. 5, while securing the front side floor cross member 18a and the rear side floor cross member 18b as floor cross members that transfer the load from the side sill 14 on the side that is struck by a side impact to the side sill 14 on the opposite side.

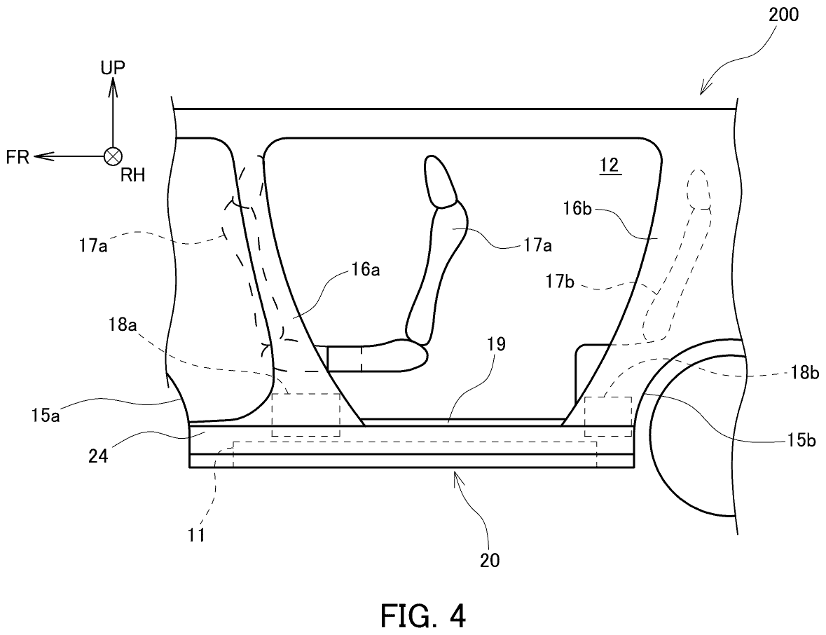

Next, the vehicle lower portion structure 20 of at least one embodiment will be described with reference to FIG. 4. The vehicle lower portion structure 20 has the same configuration as the vehicle lower portion structure 10, except that the shape of the side sill 24 is different. Therefore, the same configuration as that of the vehicle lower portion structure 10 will be omitted from the description with the same symbol.

FIG. 4 is a side view of a vehicle 200 equipped with a vehicle lower portion structure 20, viewed from the left side. As shown in FIG. 4, the vehicle lower portion structure 20 has side sills 24 that constitute part of the framework of the vehicle body. The side sill 24 is located at the ends of both sides of the vehicle in the width direction and extends along the longitudinal direction of a vehicle between a front wheel house 15a and a rear wheel house 15b. The side sill 24 has the same top height from the front end to the rear end. The height of the top end of the side sill 24 is the same height as the top end of the rear 14d of the side sill 14 of the vehicle lower portion structure 10.

Similar to the vehicle lower portion structure 10, the vehicle lower portion structure also has the front side floor cross member 18a positioned forward of the front edge of the door opening 12 and the rear side floor cross member 18b positioned behind the rear edge of the door opening 12. Therefore, unlike the vehicle lower portion structure 4 shown in FIG. 5, the vehicle lower portion structure 20 also has no floor cross member below the lower edge of the door opening 12. Therefore, the vehicle lower portion structure 20 can reduce the height of the upper edge of the side sill 24 at the portion along the lower edge of the door opening 12 compared to the vehicle lower portion structure 4 shown in FIG. 5. In addition, because the floor panel 19 connects to the upper edge of the side sill 24 in the vehicle lower portion structure 20, the floor panel 19 can be installed in a lower position compared to the vehicle lower portion structure 4 shown in FIG. 5. Therefore, the vehicle lower portion structure 20 can improve the ease of entering and exiting the vehicle compared to the prior art vehicle lower portion structure 4 shown in FIG. 5, while securing the front side floor cross member 18a and the rear side floor cross member 18b as floor cross members that transfer the load from the side sill 24 on the side that is struck by a side impact to the side sill 24 on the opposite side.

### Supplemental Information

The vehicle lower portion structure in this disclosure is not limited to the above-described embodiments, and may be implemented in various forms within the scope of the gist of this disclosure. For example, the side door openings of the vehicle may have different shapes. The vehicle in which the vehicle lower portion structure of the present disclosure is mounted may be a hybrid car.

1. A vehicle lower portion structure, comprising:
a pair of side sills extending along the longitudinal direction of a vehicle between a front wheel house and a rear wheel house, wherein the side sills are respectively disposed on both ends, in the vehicle width direction, of the vehicle;
a front frame member connected to a first side sill of the pair of side sills and extending upward from the first side sill along a front edge of a door opening defined in a side surface of the vehicle;
a rear frame member connected to the first side sill and extending upwardly from the first side sill along a rear edge of the door opening;
a front floor cross member extending along the vehicle width direction; and
a rear floor cross member extending along the vehicle width direction, wherein
the front floor cross member is forward of the front edge of the door opening and connected to the first side sill and the front frame member,
the rear floor cross member is rearward of the rear edge of the door opening and connected to the first side sill and the rear frame member.

2. The vehicle lower portion structure according to claim 1, wherein a battery is between the pair of side sills.

3. The vehicle lower portion structure according to claim 1, further comprising a floor panel,
wherein the floor panel has a portion defining a lower edge of the door opening, the portion being connected to an upper end of the first side sill.

4. The vehicle lower portion structure according to claim 2, further comprising a floor panel,
wherein the floor panel has a portion defining a lower edge of the door opening, the portion being connected to an upper end of the first side sill.
